(19) United States
(12) Patent Application Publication
(10) Pub. No.: US 2009/0325600 A1
(43) Pub. Date: Dec. 31, 2009

(54) SYSTEM AND METHOD FOR COLLECTING COMMUNICATION SIGNALS

(75) Inventor: KUAN-CHUN LEE, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/340,758

(22) Filed: Dec. 22, 2008

(30) Foreign Application Priority Data
Jun. 30, 2008 (CN) 200810302427.1

(51) Int. Cl. H04W 64/00

(52) U.S. Cl. 455/456.1

(57) ABSTRACT

A method and system for collecting communication signals include detecting one or more signals emitted by one or more base stations surrounding a communication device and acquiring one or more signal intensities of the detected one ore more signals. The method and system further include locating a position of the communication device, acquiring the position of the communication device, and transmitting the acquired one or more signal intensities and the position of the communication device to a signal collection server.

### BACKGROUND

1. Field of the Invention

Embodiments of the present disclosure relate to communication management systems and methods, and more particularly to a system and method for collecting communication signals from a plurality of communication devices.

2. Description of Related Art

A telecommunication service provider has to assign many testers to detect communication signals of various areas, so as to ensure if signal intensities of the detected communication signals of the various areas are clear enough. The signal intensities of the detected communication signals of the areas are useful for determining if base stations of the areas are distributed properly. If the base stations are distributed improperly in one area, the mobile phones cannot receive clear communication signals to communicate with others.

However, the signal detected method as described above has to be implemented by many testers, which wastes manpower and time.

What is needed, therefore, is an improved system and method for collecting communication signals without testers.

### BRIEF DESCRIPTION OF THE DRAWINGS

FIG. 1 is a block diagram of one embodiment of a hardware configuration of a system for collecting communication signals.

FIG. 2 is a block diagram of one embodiment of a communication device.

FIG. 3 is a flowchart of one embodiment of a method for collecting communication signals.

### DETAILED DESCRIPTION OF CERTAIN INVENTIVE EMBODIMENTS

All of the processes described below may be embodied in, and fully automated via, functional code modules executed by one or more general purpose computers or processors. The code modules may be stored in any type of computer-readable medium or other storage device device. Some or all of the methods may alternatively be embodied in specialized computer hardware or communication apparatus.

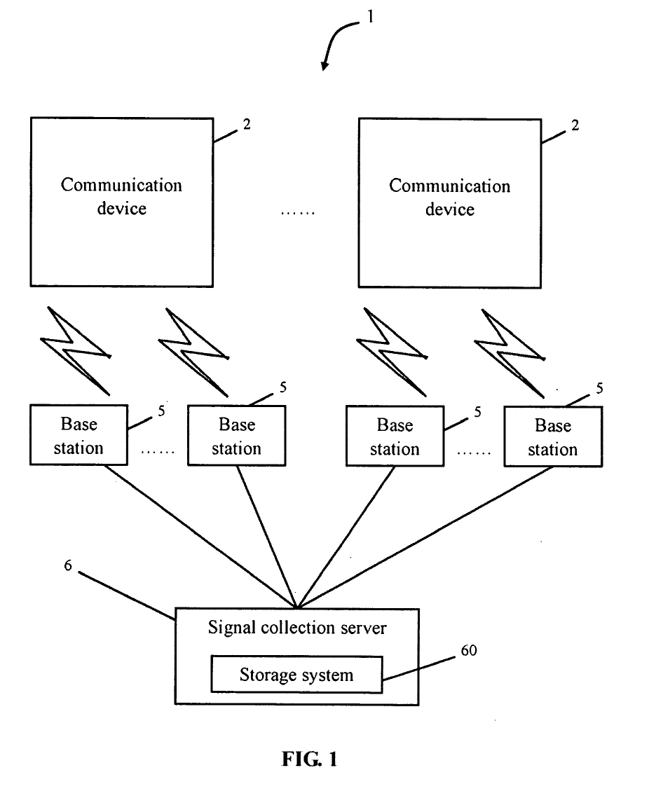

FIG. 1 is a block diagram of one embodiment of a hardware configuration of a system 1 for collecting communication signals (hereinafter referred to as “the signal collection system 1”). The signal collection system 1 may include a plurality of communication devices, such as a communication device 2, which communicates with a plurality of base stations 5 over a communication network. The communication device 2 may connect to a signal collection server 6 through the plurality of base stations 5, so as to transmit signals/data to the signal collection server 6. The communication device 2 may be a mobile phone in one embodiment. The plurality of base stations 5 are cellular towers for providing cellular signals to the communication device 2.

The signal collection server 6 may be a host computer, and is used for receiving the transmitted signals/data from the plurality of communication devices 2, and storing the transmitted signals/data into a storage system 60. Depending on the embodiment, the storage system 60 may include a memory of the signal collection server 6 or an external storing card, such as a hard disk, a mobile hard disk, for example.

The signal collection system 1 is configured for acquiring signal intensities and positions of the plurality of communication devices 2, and transmitting the signal intensities and positions to the signal collection server 6, so that the signal intensities of the corresponding positions are provided for evaluating if a distribution of the base stations 5 surrounding the positions is satisfactory. It may be understood that a telecommunication service provider may analyze the signal intensities of the corresponding positions of the communication devices 2 so as to determine if the signal intensities of different positions are strong enough, and further determine if the distribution and an amount of the base stations 5 are satisfactory.

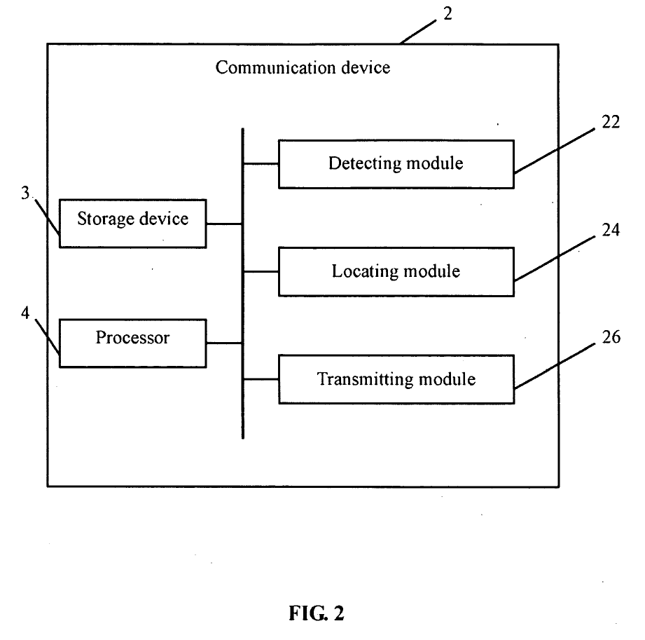

FIG. 2 is a block diagram of one embodiment of the communication device 2. In one embodiment, the communication device 2 includes a storage device 3, and at least one processor 4.

The storage device 3 is used for storing various kinds of data, such as positions of the communication device, and short messages of the communication device 2, etc. Depending on the embodiment, the storage device 3 may be a memory of the communication device 2 or an external storing card, such as a memory stick or a Subscriber Identification Module (SIM) card, for example.

In one embodiment, the communication device 2 may include a detecting module 22, a locating module 24, and a transmitting module 26. The modules 22, 24 and 26 may be used to perform one or more operations of the communication device 2. In another embodiment, the communication device 2 may include one or more specialized or general purpose processors, such as the at least one processor 4, for executing at least one operation of the modules 22, 24 and 26.

The detecting module 22 is configured for detecting one or more signals emitted by one or more base stations 5 surrounding the communication device 2, and acquiring one or more signal intensities of the detected one or more signals. As mentioned above, the signals may be cellular signals of the plurality of base stations 5.

The locating module 24 is configured for locating and acquiring a position of the communication device 2. In one embodiment, the locating module 24 may locate the position of the communication device 2 through a global position system (GPS) of the communication device 2, or the GPS and an Assisted GPS (A-GPS) so as to acquire an accurate position of the communication device 2.

In another embodiment, if the communication device 2 does not have a GPS, the locating module 24 may locate the communication device 2 by acquiring positions of at least three base stations 5 surrounding the communication device 2 and then confirm the positions of the communication device 2 according to the positions of the at least three base stations 5. Depending on the embodiment, triangulation may be used to confirm the position of the communication device 2 according to the positions of the at least three base stations 5.

The transmitting module 26 is configured for transmitting the acquired one or more signal intensities and the position of the communication device 2 to the signal collection server 6. In one embodiment, the telecommunication service provider may view the signal intensities of the corresponding positions of the communication devices 2 to determine if the signal intensities of different positions are strong enough and if the distribution and the amount of the base stations 5 are satisfactory.

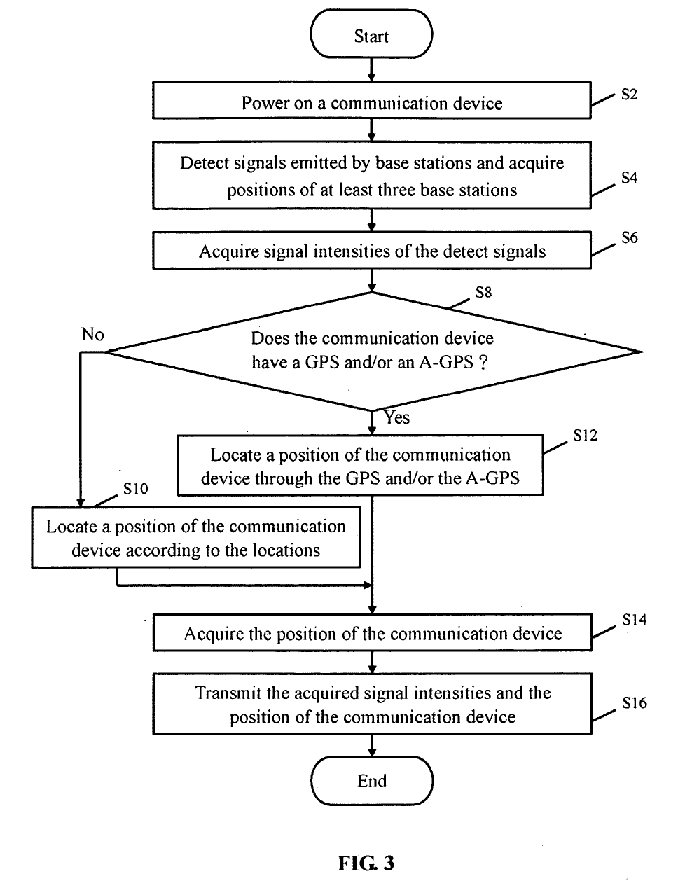

FIG. 3 is a flowchart of one embodiment of a method for collecting communication signals. Depending on the embodiment, additional blocks may be added, others removed, and the ordering of the blocks may be replaced.

In block S2, the communication device 2 is powered on.

In block S4, the detecting module 22 detects one or more signals emitted by one or more base stations 5 surrounding the communication device 2, and acquiring positions of at least three base stations 5.

In block S6, the detecting module 22 acquires signal intensities of the detected one or more signals.

In block S8, the locating module 24 determines if the communication device 2 has a GPS and/or an A-GPS. If the communication device 2 does not have a GPS and/or an A-GPS, in block S10, the locating module confirms the position of the communication device 2 according to the acquired positions of the at least three base stations 5, and then the procedure goes to block S14 directly.

If the communication device 2 has a GPS and/or an A-GPS, in block S12, the locating module locates the position of the communication device 2 through the GPS and/or the A-GPS.

In block S14, the locating module 24 acquires the position of the communication device 2.

In block S16, the transmitting module 26 transmits the acquired one or more signal intensities and the position of the communication device 2 to the signal collection server 6. A telecommunication service provider may view the signal intensities of the corresponding positions of the communication devices 2 through the signal collection server 6, so as to determine if the signal intensities of different positions are strong enough and if the distribution and the amount of the base stations 5 are satisfactory.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for collecting communication signals over a communication network comprising one or more base stations, the system comprising:
a detecting module configured for detecting one or more signals emitted by the one or more base stations surrounding a communication device, and acquiring one or more signal intensities of the detected one or more signals;
a locating module configured for locating a position of the communication device, and acquiring the position of the communication device;
a transmitting module configured for transmitting the acquired one or more signal intensities and the position of the communication device to a signal collection server; and
at least one processor that executes the detecting module, the locating module, and the transmitting module.

2. The system according to claim 1, wherein the signal collection server is established by a telecommunication service provider for collecting the signal intensities of different positions of the communication device, so as to determine if the signals of different positions are clear.

3. The system according to claim 1, wherein the locating module locates the position of the communication device by acquiring positions of at least three base stations surrounding the communication device, and confirms the position of the communication device according to the acquired positions of the at least three base stations.

4. The system according to claim 1, wherein the locating module locates the communication device through a global position system (GPS).

5. The system according to claim 1, wherein the locating module locates the communication device through a GPS and an Assisted GPS (A-GPS).

6. A method for collecting communication signals over a communication network comprising one or more base stations, the method comprising:
detecting one or more signals emitted by the one or more base stations surrounding a communication device;
acquiring one or more signal intensities of the detected one or more signals;
locating a position of the communication device and acquiring the position of the communication device; and
transmitting the acquired one or more signal intensities and the position of the communication device to a signal collection server.

7. The method according to claim 6, wherein the signal collection server is established by a telecommunication service provider for collecting the signal intensities of different positions of the communication device, so as to determine if the signals of different positions are clear.

8. The method according to claim 6, wherein the step of locating a position of the communication device and acquiring the position of the communication device comprises:
acquiring positions of at least three base stations surrounding the communication device; and
confirming the position of the communication device according to the acquired positions of the at least three base stations.

9. The method according to claim 6, wherein the step of locating a position of the communication device and acquiring the position of the communication device further comprises:
providing a global position system (GPS) for locating the position of the communication device.

10. The method according to claim 6, wherein the step of locating a position of the communication device and acquiring the position of the communication device further comprises:
providing a GPS and an Assisted GPS (A-GPS) for locating the position of the communication device.

11. A storage medium having stored thereon instructions that, when executed by a processor of a communication device, causing the processor to perform a method for collecting communication signals over a communication network comprising one or more base stations, the method comprising:
detecting one or more signals emitted by the one or more base stations surrounding a communication device;
acquiring one or more signal intensities of the detected one or more signals;
locating a position of the communication device and acquiring the position of the communication device; and
transmitting the acquired one or more signal intensities and the position of the communication device to a signal collection server.

12. The medium according to claim 11, wherein the signal collection server is established by a telecommunication service provider for collecting the signal intensities of different positions of the communication device, so as to determine if the signals of different positions are clear.

13. The medium according to claim 11, wherein the step of locating a position of the communication device and acquiring the position of the communication device comprises:
acquiring positions of at least three base stations surrounding the communication device; and
confirming the position of the communication device according to the acquired positions of the at least three base stations.

14. The medium according to claim 11, wherein the step of locating a position of the communication device and acquiring the position of the communication device further comprises:
providing a global position system (GPS) for locating the position of the communication device.

15. The medium according to claim 11, wherein the step of locating a position of the communication device and acquiring the position of the communication device further comprises:
providing a GPS and an Assisted GPS (A-GPS) for locating the position of the communication device.
